(19) United States
(12) Patent Application Publication
(10) Pub. No.: US 2026/0367475 A1
(43) Pub. Date: Nov. 19, 2026

(54) BROADBAND NON-LINEAR FREQUENCY CONVERSION IN QUASI-PHASE MATCHED NANO-PHOTONIC WAVEGUIDES

(71) Applicant: University of Rochester, Rochester, NY (US)

(72) Inventors: Qiang Lin, Rochester, NY (US); Jeremy Staffa, Westport, NY (US); Gareth Valentine, Kirkland, WA (US); Zhimin Shi, Bellevue, WA (US)

(21) Appl. No.: 19/137,103

(22) PCT Filed: Dec. 18, 2023
(86) PCT No.: PCT/US2023/084571

§ 371 Date: Jun. 9, 2025

Related U.S. Application Data
(60) Provisional application No. 63/433,539, filed on Dec. 19, 2022.

(51) Int. Cl. G02F 1/365; G02F 1/35

(52) U.S. Cl. CPC G02F 1/365; G02F 1/3548

(57) ABSTRACT

A system includes one or more light sources and a nonlinear waveguide having an optical nonlinearity configured to convert an input beam provided by the one or more light sources from a current input wavelength to a specified output wavelength. The input beam includes a spatial mode that is different in order than a fundamental spatial mode. The converted output wavelength includes a spatial mode that is different in order than the spatial mode of the input beam. The wavelength conversion reduces a first order dispersion of phase mismatch between the input wavelength and the output wavelength.

### REFERENCE TO RELATED APPLICATIONS

This application is a national stage application under 35 U.S.C. § 371 of PCT Application No. PCT/US2023/084571, filed Dec. 18, 2023, BROADBAND NON-LINEAR FREQUENCY CONVERSION IN QUASI-PHASE MATCHED NANO-PHOTONIC WAVEGUIDES, published as WO 2024/137477 A1, which claims priority to U.S. Provisional Patent Application Ser. No. 63/433,539 filed on Dec. 19, 2022.

### TECHNICAL FIELD

The present application relates compact, high-speed tunable coherent light sources and their fabrication including, but not restricted to, visible wavelength and narrowband lasers and their fabrication from native visible emitting semiconductor materials.

### BACKGROUND OF THE INVENTION

Electronic visual displays used in some applications may benefit from compact laser sources that are quickly tunable over broad color (wavelength) ranges. Current infrared (IR) lasers can provide such wavelength tunability, but most visible lasers cannot. Some prior attempts have been made to use an IR source laser and then convert the IR output to visible light. This, however, requires active control of the IR source laser beyond wavelength tuning, including directly modulating the source laser's operating temperature to efficiently convert IR source outputs to visible light wavelengths even over moderate bandwidths

Next-generation display technologies will require the capability of varying the emission wavelength of the illuminating light source at high speed. In this way, passive optical elements can be designed to respond differently at different wavelengths without requiring any direct active control. For displays, this will require a supply of compact, high-speed tunable red, green and blue narrowband lasers. Development and fabrication of such high-speed tunable lasers from native visible emitting semiconductor material requires must overcome challenges associated with the semiconductor material limitations, particularly in regards to development of tunable green lasers.

An alternative approach with a considerably shorter development timescale and fewer fundamental material challenges is to make use of already existent tunable infra-red lasers and implement efficient nonlinear optical conversion techniques to generate tunable visible emission. For example, in display technologies, precise control of the backlight wavelength for advanced display applications is an avenue that until now has not been fully exploited. One important reason for this is the absence of compact and efficient tunable laser devices operating in the visible region. To achieve desired results in such application requires a device that will convert compact tunable infra-red lasers that already exist into tunable visible light using compact and efficient nonlinear techniques.

Another challenge is to maintain phase matching between the fundamental infra-red input and converted visible emission as the input laser is rapidly tuned. Without phase-matching, conversion efficiency very quickly drops to near zero as the wavelength is tuned away from peak conversion. Usually, such structures have very narrow phase matching bandwidths and must be temperature tuned to maintain phase matching as the wavelength is varied. Such temperature tuning is slow and not normally compatible with the intended display applications.

Nonlinear optical parametric processes such as second harmonic generation (“SHG”), sum-frequency generation (“SFG”), difference-frequency generation (“DFG”), optical parametric oscillation (“OPO”), parametric down-conversion (“PDC”), and others are well studied techniques for converting optical signals among different wavelengths which have found broad applications such as in optical communications, spectroscopy, laser frequency conversion, and quantum sciences. The conversion efficiencies of these processes rely crucially on strict phase matching among the interacting optical waves. Realization of phase matching, however, is not trivial since the underlying nonlinear medium inevitably exhibits material dispersion with significant refractive index difference between the pump wave and the converted wave(s), resulting in significant phase mismatch that degrades the conversion efficiency. A few approaches have been developed to date to achieve phase matching, such as birefringence phase matching, intermodal phase matching, and periodic poling. Among these approaches, the periodic poling approach exhibits significantly higher efficiency of frequency conversion, in which the orientation of a ferroelectric material is alternated periodically to flip the sign of the second-order nonlinearity, thus bridging the momentum mismatch to achieve quasi-phase matching (“QPM”).

For applications of optical frequency conversion, one important characteristic is the wavelength tunability of the converted light, which is determined by the bandwidth of phase matching. All the phase matching approaches developed to date exhibit a limited phase matching bandwidth. The primary reason lies in that the bandwidth of phase matching is governed by the first-order and high-order dispersion properties of the nonlinear waveguide. Although these dispersions can be engineered to a certain extent at a long-wavelength spectral region (say, mid-infrared and telecommunications band) where the material dispersion becomes small, it imposes significant challenge in spectral regions, such as the near-infrared, visible, and ultraviolet regions, where the material dispersion becomes significant. So far, frequency conversion in the visible region exhibits fairly limited bandwidth in the order of about one nanometer (“nm”). Obstacles to achieving broadband frequency conversion in this spectral region remain a challenge.

### SUMMARY OF THE INVENTION

The inventors have surprisingly discovered a novel method for broadband optical frequency conversion termed herein as inverse-intermodal quasi-phase matching (“inverse-intermodal QPM”). In some embodiments of this approach, a nonlinear waveguide is periodically poled to achieve phase-matched frequency conversion between different-order guided modes of the waveguide. Specifically, higher-order guided mode(s) are chosen for the lower optical frequencies and the lower- or lowest-order guided mode is chosen for the higher optical frequency.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A shows a block diagram illustrating use of the broadband optical frequency conversion based on inverse-intermodal QPM with a converter and nanophotonic waveguide in accordance with embodiments of the present disclosure.

FIG. 1B shows a block diagram illustrating use of the broadband optical frequency conversion based on inverse-intermodal QPM with a nanophotonic waveguide in accordance with embodiments of the present disclosure.

FIG. 2 shows a cross-sectional diagram of an inverse-intermodal QPM nanophotonic waveguide in accordance with embodiments of the present disclosure.

FIG. 3 shows a prospective diagram illustrating an inverse-intermodal QPM nanophotonic waveguide in accordance with embodiments of the present disclosure.

FIG. 4A shows contours of equal normalized electric field for the fundamental mode of the fundamental harmonic superimposed on the cross-sectional diagram of a nanophotonic waveguide in a traditional Type-0 quasi phase-matching approach in accordance with embodiments of the present disclosure.

FIG. 4B shows contours of equal normalized electric field for the fundamental mode of the second harmonic superimposed on the cross-sectional diagram of a nanophotonic waveguide in a traditional Type-0 quasi phase-matching approach in accordance with embodiments of the present disclosure.

FIG. 5A shows contours of equal normalized electric field for the TE₁₀ of the fundamental harmonic superimposed on the cross-sectional diagram of a nanophotonic waveguide using the inverse-intermodal QPM approach in accordance with embodiments of the present disclosure.

FIG. 5B shows contours of equal normalized electric field for the fundamental mode of the second harmonic superimposed on the cross-sectional diagram of a nanophotonic waveguide using the inverse-intermodal QPM approach in accordance with embodiments of the present disclosure.

FIG. 6A shows contours of equal normalized electric field values for a pump mode with higher order than TE₁₀ (the TE₂₀ mode) of the fundamental harmonic superimposed on the cross-sectional diagram of a nanophotonic waveguide using the inverse-intermodal QPM approach in accordance with embodiments of the present disclosure.

FIG. 6B shows contours of equal normalized electric field for a TE₀₀ mode of a second harmonic of a pump mode with higher order than TE₁₀ (the TE₂₀ mode) superimposed on the cross-sectional diagram of a nanophotonic waveguide using the inverse-intermodal QPM approach in accordance with embodiments of the present disclosure.

FIG. 7A shows contours of equal normalized electric field for a pump mode with orthogonal polarization and higher spatial mode order (TM₁₀) superimposed on the cross-sectional diagram of a nanophotonic waveguide using the inverse-intermodal QPM approach in accordance with embodiments of the present disclosure.

FIG. 7B shows contours of equal normalized electric field for a TE₀₀ mode of a second harmonic of a pump mode with orthogonal polarization and higher spatial mode order (TM₁₀) superimposed on the cross-sectional diagram of a nanophotonic waveguide using the inverse-intermodal QPM approach in accordance with embodiments of the present disclosure.

FIG. 8A shows contours of equal normalized electric field for the TE₂₀ mode of the fundamental harmonic in a quasi phase-matched third harmonic process superimposed on the cross-sectional diagram of a nanophotonic waveguide using the inverse-intermodal QPM approach in accordance with embodiments of the present disclosure.

FIG. 8B shows contours of equal normalized electric field for the TE₀₀ mode of the third-harmonic of the quasi phase-matched third harmonic process of FIG. 8A superimposed on the cross-sectional diagram of a nanophotonic waveguide using the inverse-intermodal QPM approach in accordance with embodiments of the present disclosure.

FIG. 9A shows contours of equal normalized electric field for the TE₂₀ mode of the fundamental harmonic for a pump process using higher order modes superimposed on the cross-sectional diagram of a nanophotonic waveguide using the inverse-intermodal QPM approach in accordance with embodiments of the present disclosure.

FIG. 9B shows contours of equal normalized electric field for the TE₁₀ mode of the second harmonic for a pump process using higher order modes superimposed on the cross-sectional diagram of a nanophotonic waveguide using the inverse-intermodal QPM approach in accordance with embodiments of the present disclosure.

FIG. 10 shows contours of first order dispersion of the phase mismatch for the SHG process for the Type-0 phase matching approach in accordance with embodiments of the present disclosure.

FIG. 11 shows contours of first order dispersion of the phase mismatch for the SHG process for a TE₁₀ mode for the fundamental frequency in accordance with embodiments of the present disclosure.

FIG. 12 displays the comparison of the dispersion of the Type-0 process to the inverse-intermodal QPM process in accordance with embodiments of the present disclosure.

FIG. 13 displays the efficiency at various normalized propagation lengths of the Type-0 process in accordance with embodiments of the present disclosure.

FIG. 14 displays the efficiency at various normalized propagation lengths of the inverse-intermodal QPM process in accordance with embodiments of the present disclosure.

FIG. 15 displays the normalized conversion efficiency of the SHG process in the case of Type-0 phase matching in accordance with embodiments of the present disclosure.

FIG. 16 displays the normalized conversion efficiency of the SHG process in the case of a TE₁₀ for the fundamental frequency in accordance with embodiments of the present disclosure.

### DETAILED DESCRIPTION

The present disclosure may implement conventional light sources including lasers and, in contrast to comparative approaches, may use nonlinear frequency conversion to convert from a source wavelength to another wavelength of light (for example, visible light typically between 380 to 700 nanometers (“nm”)) over relatively broad bandwidths without having to actively modulate the operating temperature of the source lasers.

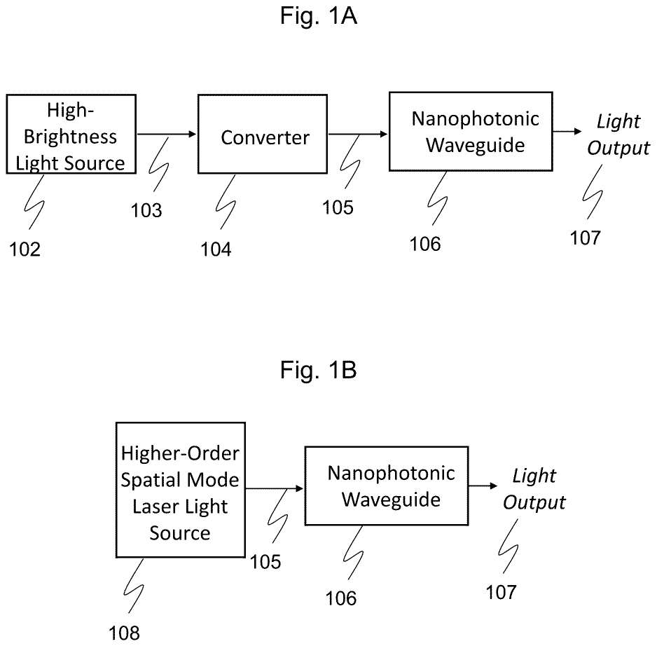

FIG. 1A illustrates an exemplary embodiment of system described herein comprising a high-brightness light source 102 used in conjunction 103 with a converter 104 that converts a fundamental order spatial mode laser output to a higher order spatial mode laser output. Without being bound by theory or otherwise limited, examples of such a light source may be a laser such as an infra-red (“IR”) source laser, an ultraviolet (“UV”) source laser, a visible light source laser, or similar or equivalent source. The brightness level in these light sources may be designated to be above at least a minimum threshold brightness level. The higher order light source 102 output 103 (for example, laser light output) passes through the converter 104 and is directed 105 through a (nanophotonic) waveguide 106 that incorporates specially designed optical nonlinearities. The optical nonlinearities may be designed to receive a (higher or lower) order spatial mode laser output and produce a (higher or lower) order spatial mode visible laser output 107. This converted spatial mode visible laser output may be a single-colored or multi-colored visible laser output that is quickly and efficiently tunable over a desired broad bandwidth, without having to directly control the source laser operating temperature.

Other embodiments may implement a modified source laser that is specifically designed to generate higher order spatial mode laser outputs as illustrated in the embodiment shown in FIG. 1B. In such cases, no converter is needed, and the higher order spatial mode laser outputs can travel directly from the source laser 108 to the nanophotonic waveguide 106 where (higher or lower) order spatial mode laser outputs will be converted to (higher or lower) order spatial mode visible laser outputs 107 through nonlinear frequency conversion. These converted visible spatial mode laser outputs may then be used in different types of electronic displays including augmented reality (AR) displays, virtual reality (VR) displays, or other types of electronic displays. Additionally, or alternatively, the converted visible spatial mode laser output may be used by laser manufacturers to change the wavelength band of an existing laser product produced by the manufacturer. Other instances in which converted visible spatial mode laser outputs may be implemented to change wavelength bands are also contemplated herein.

By using tunable lasers in combination with efficient, nonlinear optical conversion techniques to generate tunable visible emissions, the embodiments described herein may have a relatively short development timescale with greater material flexibility. The embodiments herein may be configured to maintain phase matching between a laser input and second harmonic generation (“SHG”) visible emissions for efficient conversion as the input laser is rapidly tuned over relatively broad bandwidths. Without phase-matching, SHG conversion efficiency may quickly drop to a value near zero as the wavelength is tuned away from peak conversion. In addition to SHG, other nonlinear processes may implement some or all of the embodiments described herein, including sum-frequency generation (“SFG”), difference-frequency generation (“DFG”), parametric down-conversion (“PDC”), or other similar processes.

The embodiments described herein may provide an approach that maintains efficient phase matching over a broad range of input wavelengths without requiring any active control of the source laser such as temperature variation. In this manner, high-speed tunability of converted visible emissions (for example, red, green, or blue emission) may be provided and maintained. In some cases, the high-speed tunability may correspond to the speed of the tunable pump source laser.

In the discussion that follows, one skilled in the art of optical waveguide engineering may exploit that a transverse mode of electromagnetic radiation is a particular electromagnetic field pattern of the radiation in the plane perpendicular (i.e., transverse) to the radiation's propagation direction. Transverse modes occur because of boundary conditions imposed on the wave by the waveguide and the modes supported by a waveguide are quantized. The allowed modes can be found by solving Maxwell's equations for the boundary conditions of a given waveguide. By convention, modes in waveguides can be classified according to the following conventions: Transverse electric (“TE”) modes (sometimes called “H waves”) may be referred to as TEₘₙ modes, where m denotes the number of nodes of the fields in the horizontal direction and n denotes the number of nodes of the fields in the vertical direction. Transverse magnetic (“TM”) modes (sometimes called “E waves”) may be referred to as TMₘₙ modes, where m denotes the number of nodes of the fields in the horizontal direction and n denotes the number of nodes of the fields in the vertical direction.

As described herein, pumping allows the higher order spatial mode laser output to be converted from the higher order spatial mode to a lower order spatial mode that is lower than the higher order spatial mode, and in particular embodiments may be converted to the fundamental spatial mode. In some examples, these embodiments may include second harmonic generation in a waveguide fabricated on a material with a non-zero χ⁽²⁾(“chi-2”). Additionally or alternatively, these embodiments may be used for nonlinear interactions such as sum-frequency generation (SFG) and/or difference-frequency generation (DFG) in χ⁽²⁾ materials, or in χ⁽³⁾ (“chi-3”) interactions (such as third harmonic generation) in general dielectric waveguides.

In some embodiments, the systems described herein may maintain a phase-matched condition for SHG and/or SFG by ensuring a low group velocity mismatch (“GVM”) across the active operating wavelength range. When optical pulses with different optical frequencies propagate in a transparent medium (for example, in an optical crystal), their group velocities will in general be different. As a result of this group velocity mismatch, two pulses which are initially overlapping in time can after some propagation distance no longer overlap. Ensuring such a low GVM may be problematic for devices designed to convert from IR light, for example, to visible wavelengths due to a marked difference in material dispersion at IR and visible light extremes. Indeed, the visible light in such scenarios may approach the strong absorption of typical nonlinear waveguide material such as lithium niobite (“LN”) near 350 nm and, as such, the material refractive index may change rapidly.

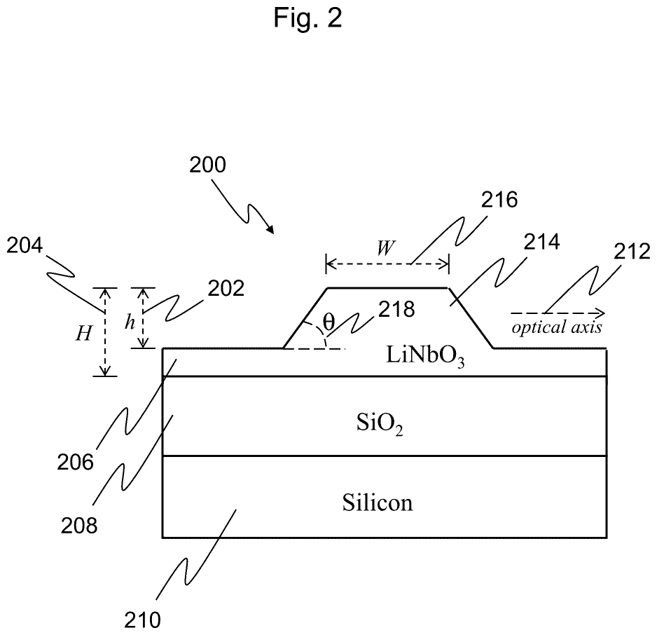

FIG. 2 illustrates an embodiment for the case of a lithium-niobate-on-insulator (“LNOI”) waveguide 200 that is periodically poled for SHG. The LNOI waveguide is comprised of a layer of lithium niobate (LiNbO₃) 206 disposed on a layer of silicon dioxide (SiO₂) 208, and the composition is further disposed on a layer of silicon (Si) 210. The LiNbO₃ layer further comprises a trapezoidal structure 214 in cross-section etched into the upper surface of top width 216, W, etch depth 202, h, and sidewall angle 218, 0, wherein the thickness 204 of the LiNbO₃ layer is denoted, H. The waveguide is fabricated from an X-cut thin film with a SiO₂ bottom cladding an Si substrate. In practice, the pump wave is launched into the second-order quasi-transverse-electric (quasi-TE) guided mode (namely, the TE₁₀ mode) while the second harmonic light is produced inside the fundamental quasi-TE mode (namely, the TE₀₀ mode). As described below, such an approach is able to achieve broadband QPM with a bandwidth significantly beyond the reach of conventional phase matching techniques.

The dimensions of the waveguide depend upon the design wavelengths and material properties based on principles known by one skilled in the art of optical waveguide physics. For embodiments for use in practical applications in the visible spectrum, waveguide thicknesses, H, between 100 nanometers (nm), or 150 nm, or 200 nm, or 250 nm, or 300 nm, or 350 nm and 600 nm, or 650 nm, or 700 nm, or 800 nm, or 850 nm, or 900 nm, or 950 nm, or 1,000 nm, or 1,050 nm, or 1,100 nm, or 1,150 nm, or 1,200 nm. The foregoing upper and lower bounds can be independently combined. Waveguide thicknesses, H, are between approximately 300 nm and 800 nm are specifically mentioned. Waveguide thicknesses, H, between approximately 100 nm and 1,200 nm are specifically mentioned. For a particular embodiment, if H* is the design waveguide thickness, then etched depths, h, are between H* divided by six (H*/6) and H* are practical with today's manufacturing techniques which are expected to improve. Thus, for a particular embodiment, if H* is the design waveguide thickness, etched depths, h, between (H*/6), or (H*/5), or (H*/4), or (H*/3), or (H*/2) and H*. The foregoing upper and lower bounds can be independently combined. Etched depths, h, are between (H*/6) and H* is specifically mentioned. Etched depths, h, between (H*/3) and H* is specifically mentioned. Etched depths, h, between (H*/6) and H* is specifically mentioned. Etched depths, h, between 100 nm and 800 nm is specifically mentioned. Etched depths, h, between 35 nm and 1,200 nm is also specifically mentioned. For embodiments for use in practical applications in the visible spectrum, waveguide top widths, W, are between 300 nm, or 350 nm, or 400 nm, or 450 nm, or 500 nm, or 550 nm, or 600 nm, or 650 nm, or 700 nm, or 750 nm, or 800 nm, or 850 nm, or 900 nm, or 950 nm, or 1,000 nm and 2 micrometers (μm), or 2.5 μm, or 3 μm. Waveguide top widths, W, between 500 nm and 3 μm is specifically mentioned. Practical limitations for the waveguide angle, θ, are imposed by current manufacturing methods typically in use today but can be expected to improve and manufacturable waveguide angles as close to 90 degrees may be desirable for some embodiments. Waveguide angles, θ, are between approximately 0.1 degrees and 90 degrees. Waveguide angles, θ, between 1 degree and 90 degrees is specifically mentioned. Waveguide angles, θ, between 5 degree and 90 degrees is also specifically mentioned. Waveguide angles, θ, between 5 degrees and 85 degrees is also specifically mentioned.

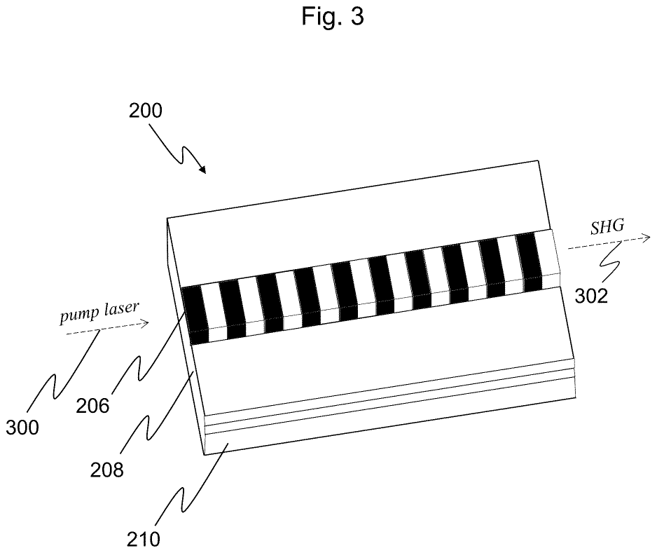

FIG. 3 shows a perspective drawing for an embodiment of a LNOI waveguide 200 that is periodically poled for SHG as depicted in the embodiment shown in FIG. 2. In the embodiment shown, the etched trapezoidal surface structure 206 is comprised of alternating regions of lithium niobate crystal with alternating longitudinal axis vector orientation. The etched lithium niobate layer is disposed on a layer of silicon dioxide (SiO₂) 208, and the composition is further disposed on a layer of silicon (Si) 210. Light from the pump light source 300 enters the waveguide and the periodically pumped process produces output light 302 by second harmonic generation (SHG).

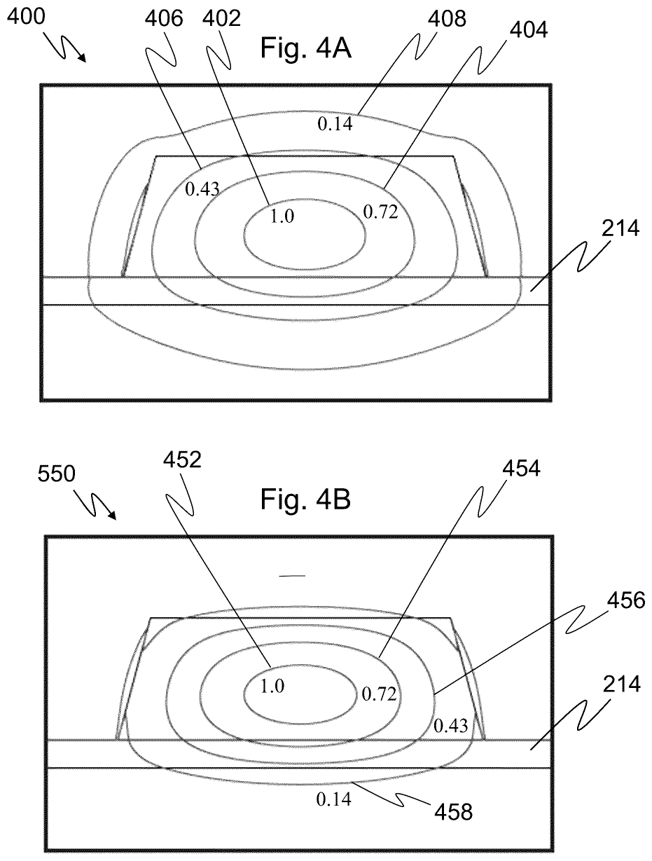

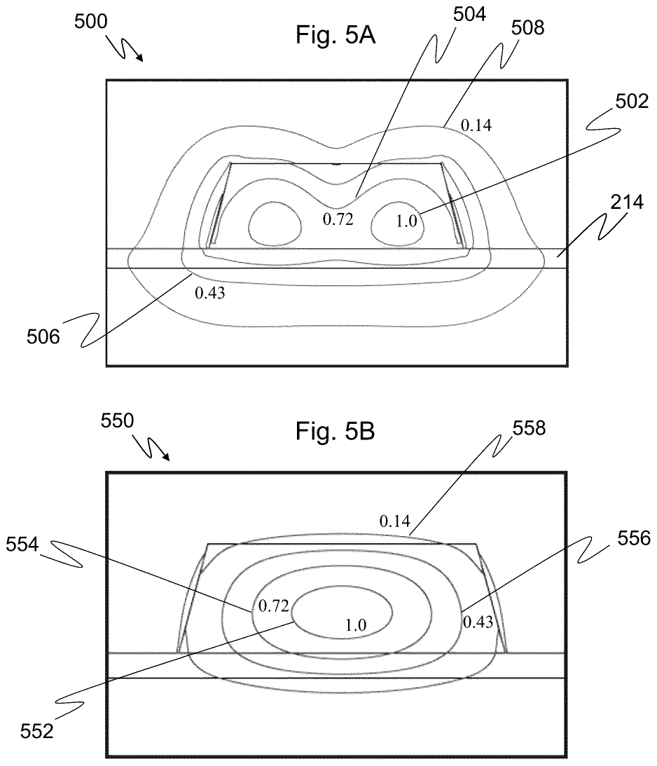

The inverse-intermodal QPM methods illustrated in the embodiments is the opposite of conventional intermodal phase matching in which the high-frequency optical wave has to stay in a higher-order guided mode to lower down its refractive index so as to match that of the low-frequency optical wave(s) which has to stay in a lower-order guided mode (typically the lowest-order mode) to retain its relatively high refractive index. The fundamental reason underlying the present disclosure is that the refractive index of a nonlinear medium generally increases with optical frequency, and phase matching would thus require decreasing the refractive index of high-frequency optical wave, or increasing that of low-frequency one(s). The proposed approach is also distinctive from the conventional Type-0 QPM in which all the optical waves stay in the same fundamental guided mode (TE₀₀ or TM₀₀ mode) and illustrated by the simulated exemplary embodiment with comparative performance shown in FIG. 4A through FIG. 5B. (In conventional Type-I or Type-II QPM, the pump and converted waves both still stay in the fundamental guided modes but with different polarizations). Neither of the conventional approaches is able to achieve broadband phase matching in the visible region that is achievable using the application of inverse-intermodal QPM.

FIG. 4A displays a plot 400 of contours of constant values of normalized (nondimensional) electric field distribution,

$$\frac{\sqrt{{\vert 𝔈 ( x , y , z ) \vert}^{2}}}{max \vert 𝔈 ( x , y , z ) \vert}$$

simulated by finite elements methods (FEM) using the COMSOL Multiphysics Software program, where @ (x, y, z) is the electric field distribution (kg·m·sec⁻³·Area⁻¹; alternatively, by conversion, Volts per meter or Newtons per Coulomb) supported by the lithium niobate crystal as a function of cartesian coordinates for fundamental mode involved in a tradition Type-0 quasi phase-matching approach. Simulation values for the waveguide structure are displayed in Table 1.

TABLE 1
COMSOL Simulation Parameters

| Parameter | Value | Units |
|---|---|---|
| Light Source Wavelength | 1,064 | nm |
| Top Width, W | 800 | nm |
| Total Layer Thickness, H | 400 | nm |
| Etched Depth, h | 325 | nm |
| Sidewall Angle, θ | 75 | degrees |

Thus, it follows that the second harmonic wavelength used in the simulation and presented in the exemplary figures that follows is 532 nm.

FIG. 4A displays a plot 400 of normalized electric field distribution contours of 1.0 normalized value 402, 0.72 normalized value 404, 0.43 normalized value 406, and 0.14 normalized value 408 for the fundamental TE₀₀ mode applying a tradition Type-0 quasi phase-matching approach.

FIG. 4B displays a plot 450 of contours of constant values of normalized electric field distribution simulated using COMSOL, supported by the lithium niobate crystal as a function of cartesian coordinates for a second harmonic mode in a tradition Type-0 quasi phase-matching approach corresponding to simulation parameters shown in TABLE 1. Normalized electric field distribution values of 1.0 normalized value 452, 0.72 normalized value 454, 0.43 normalized value 456, and 0.14 normalized value 458 are shown for the second harmonic TE₀₀ mode applying a tradition Type-0 quasi phase-matching approach.

FIG. 5A displays a plot 500 of contours of constant values of normalized electric field distribution simulated using the COMSOL for the higher order mode TE₁₀ involved in the inverse-intermodal QPM method corresponding to simulation parameters shown in TABLE 1. Normalized electric field distribution values of 1.0 normalized value 502, 0.72 normalized value 504, 0.43 normalized value 506, and 0.14 normalized value 508 are shown for the higher order mode TE₁₀ applying the inverse-intermodal QPM method.

FIG. 5B displays a plot 550 of contours of constant values of normalized electric field distribution simulated using COMSOL, supported by the lithium niobate crystal as a function of cartesian coordinates for a second harmonic mode in the inverse-intermodal QPM method corresponding to simulation parameters shown in TABLE 1. Normalized electric field distribution values of 1.0 normalized value 552, 0.72 normalized value 554, 0.43 normalized value 556, and 0.14 normalized value 558 are shown for the second harmonic mode TE₀₀ applying the inverse-intermodal QPM method.

Moreover, the material platform need not be restricted to LNOI as depicted in FIG. 2 and FIG. 3. Any nanophotonic material platform on which waveguides can be fabricated could leverage this invention, since in principle all nanophotonic material platforms have some nonlinearity that can be used for frequency conversion and some capacity to realize quasi-phase matching (for example, by sidewall modulation instead of periodic poling). This includes, but not restricted to, exemplary compounds such as silicon nitride and gallium arsenide.

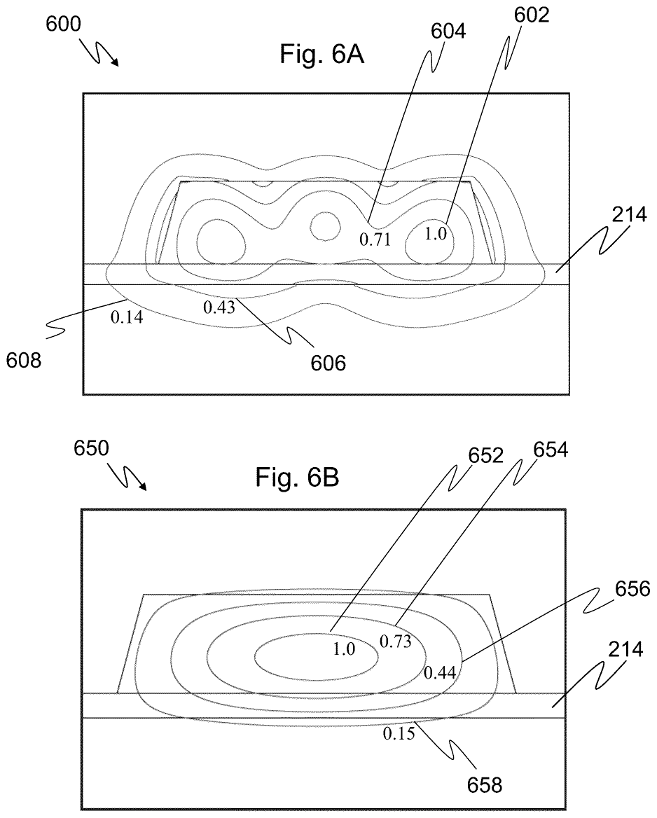

The invention can be generalized beyond SHG with a TE₁₀ mode for the pump. FIG. 6A through FIG. 9B illustrates exemplary embodiments results for a non-exhaustive set of some possible extensions and generalizations embodiments previously described. A pump mode of higher order than TE₁₀, such as TE₂₀ and beyond, can be used to achieve a broad bandwidth. A higher order mode can be used for the second harmonic as well in a broader generalization of the invention. Additionally, opposite mode polarizations of the pump and SH can be employed, which can interact through χ⁽²⁾ tensor elements such as d₃₁ in LNOI, for example.

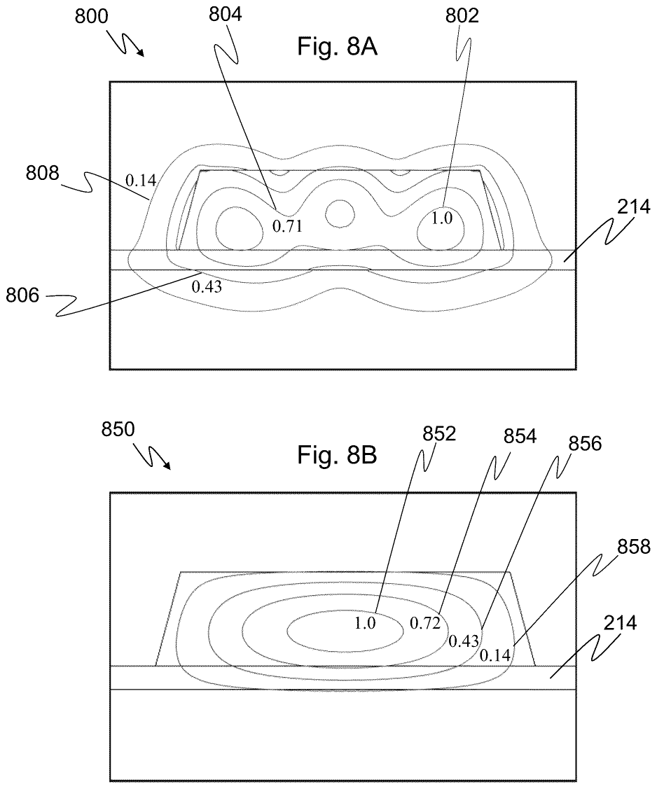

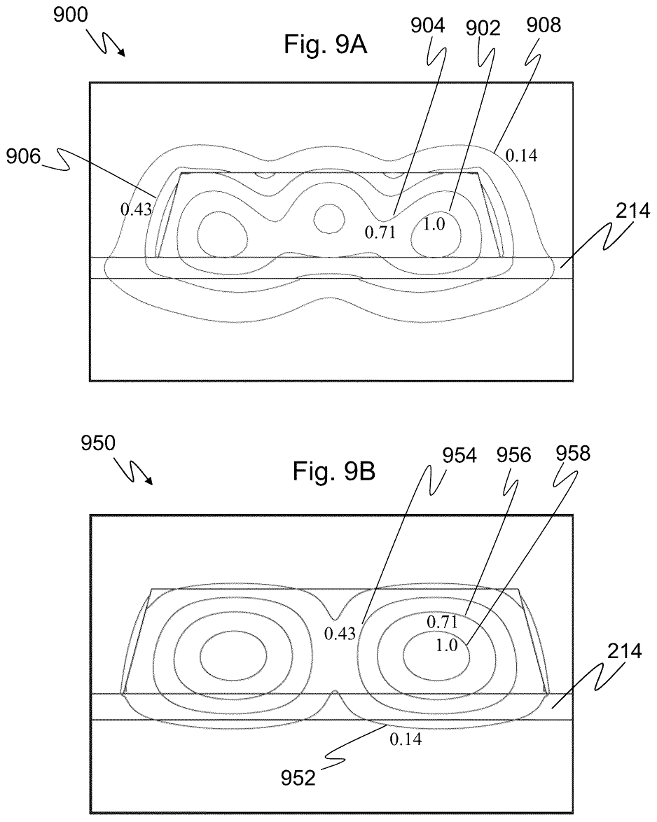

Simulation values for the waveguide structure for an embodiment with results for FIG. 6A and FIG. 6B, and FIG. 8A through FIG. 9B are displayed in Table 2.

TABLE 2
COMSOL Simulation Parameters

| Parameter | Value | Units |
|---|---|---|
| Light Source Wavelength | 1,064 | nm |
| Top Width, W | 1,400 | nm |
| Total Layer Thickness, H | 500 | nm |
| Etched Depth, h | 400 | nm |
| Sidewall Angle, θ | 75 | degrees |

Thus, it follows that the second harmonic wavelength used in the simulation and presented in the exemplary figures that follows is 532 nm and the third harmonic wavelength is 1,064 nm divided by three (equals approximately 354.67 nm).

FIG. 6A displays a plot 600 of contours of constant values of normalized electric field distribution simulated using the COMSOL for a pump mode of higher order than TE₁₀ involved in the inverse-intermodal QPM method corresponding to simulation parameters shown in TABLE 2. Normalized electric field distribution values of 1.0 normalized value 602, 0.71 normalized value 604, 0.43 normalized value 606, and 0.14 normalized value 608 are shown for the fundamental mode (2ω) TE₂₀ applying the inverse-intermodal QPM method.

FIG. 6B displays a plot 650 of contours of constant values of normalized electric field distribution simulated using COMSOL, supported by the lithium niobate crystal as a function of cartesian coordinates for a pump mode of higher order than TE₁₀ involved in the inverse-intermodal QPM method corresponding to simulation parameters shown in TABLE 2. Normalized electric field distribution values of 1.0 normalized value 652, 0.73 normalized value 654, 0.44 normalized value 656, and 0.14 normalized value 658 are shown for the second harmonic mode (2ω) TE₀₀ applying the inverse-intermodal QPM method.

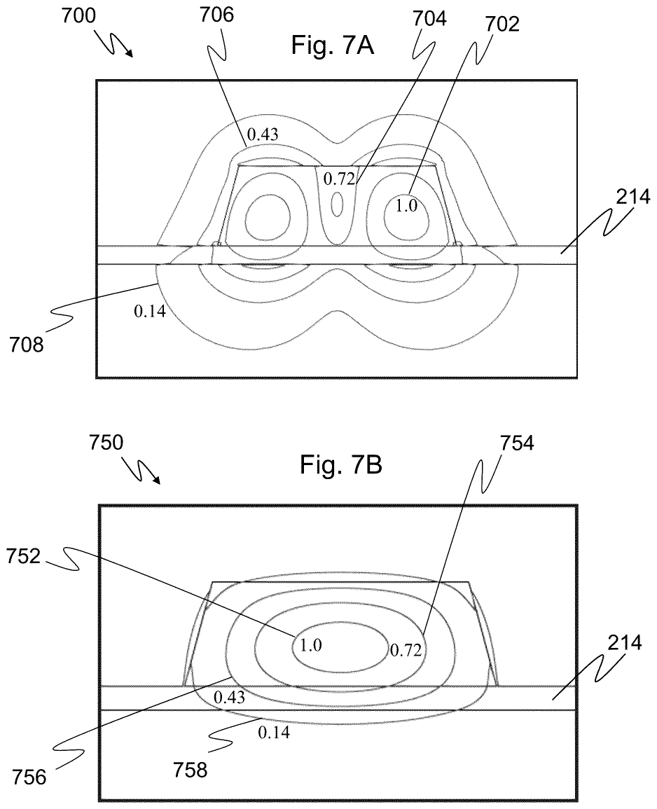

FIG. 7A displays a plot 700 of contours of constant values of normalized electric field distribution simulated using the COMSOL for modes with orthogonal polarization involved in the inverse-intermodal QPM method corresponding to simulation parameters shown in TABLE 1. Normalized electric field distribution values of 1.0 normalized value 702, 0.72 normalized value 704, 0.43 normalized value 706, and 0.14 normalized value 708 are shown for the fundamental mode (ω) TM₁₀ applying the inverse-intermodal QPM method.

FIG. 7B displays a plot 750 of contours of constant values of normalized electric field distribution simulated using COMSOL, supported by the lithium niobate crystal as a function of cartesian coordinates for modes with orthogonal polarization in the inverse-intermodal QPM method corresponding to simulation parameters shown in TABLE 1. Normalized electric field distribution values of 1.0 normalized value 752, 0.73 normalized value 754, 0.44 normalized value 756, and 0.14 normalized value 758 are shown for the second harmonic mode (2ω) TE₀₀ applying the inverse-intermodal QPM method.

FIG. 8A displays a plot 800 of contours of constant values of normalized electric field distribution simulated using the COMSOL for a fundamental mode corresponding to simulation parameters shown in TABLE 2. Normalized electric field distribution values of 1.0 normalized value 802, 0.71 normalized value 804, 0.43 normalized value 806, and 0.14 normalized value 808 are shown for the fundamental mode (ω) TE₂₀ applying the inverse-intermodal QPM method.

FIG. 8B displays a plot 850 of contours of constant values of normalized electric field distribution simulated using COMSOL, supported by the lithium niobate crystal as a function of cartesian coordinates for a quasi phase-matched third harmonic process corresponding to simulation parameters shown in TABLE 2. Normalized electric field distribution values of 1.0 normalized value 852, 0.72 normalized value 854, 0.43 normalized value 856, and 0.14 normalized value 858 are shown for the third harmonic mode (3ω) TE₀₀ applying the inverse-intermodal QPM method.

FIG. 9A displays a plot 900 of contours of constant values of normalized electric field distribution simulated using the COMSOL using higher order modes at both the pump and second harmonic corresponding to simulation parameters shown in TABLE 2. Normalized electric field distribution values of 1.0 normalized value 902, 0.71 normalized value 904, 0.43 normalized value 906, and 0.14 normalized value 908 are shown for the fundamental mode (ω) TE₂₀ applying the inverse-intermodal QPM method.

FIG. 9B displays a plot 950 of contours of constant values of normalized electric field distribution simulated using COMSOL, supported by the lithium niobate crystal as a function of cartesian coordinates using higher order modes at both the pump and second harmonic corresponding to simulation parameters shown in TABLE 2. Normalized electric field distribution values of 1.0 normalized value 952, 0.72 normalized value 954, 0.43 normalized value 956, and 0.14 normalized value 958 are shown for the second harmonic mode (2ω) TE₁₀ applying the inverse-intermodal QPM method.

The nonlinear process does not need to be SHG either. Any quasi phase-matched second order frequency conversion process, such as SFG or DFG, can leverage this invention for a broad conversion bandwidth. Furthermore, higher-order optical nonlinearities than χ⁽²⁾ can be used for the frequency conversion process, such as third harmonic generation from the χ⁽³⁾ nonlinearity as illustrated in FIG. 8A and FIG. 8B, since a means other than periodic poling can be used to achieve quasi phase-matching (such as periodic sidewall modulation, or any other periodic structure introduced to the waveguide for phase-matching).

A feature of inverse-intermodal QPM is that embodiments according to the disclosure can achieve broadband QPM with bandwidth significantly greater than that of existing methods and superior phase-matching bandwidth. To illustrate an advantage of inverse-intermodal QPM, consider an example of SHG for a 1,064 nm tunable laser source in a periodically-poled X-Cut LNOI nanophotonic waveguide. In SHG, the phase mismatch is defined as:

$$Δ β ( ω ) = {β}_{2} ( 2 ω ) - 2 {β}_{1} ( ω ) - \frac{2 π}{Λ}$$

where βⱼ (j=1,2) is the propagation constant of the fundamental (j=1) or second harmonic frequency mode (j=2), A is the poling period, and @ is the angular frequency of the pump laser. The efficiency of the SHG process has the following approximate proportionality,

$$Γ ( ω ) ∝ {sinc}^{2} ( \frac{Δ β ( ω ) L}{2} )$$

where L is the length of the periodic poled lithium niobate waveguide. These equations show that any nonzero phase mismatch would lead to a degradation of SHG efficiency. The period of periodic poling, A, can be chosen to satisfy quasi-phase matching at a certain pump frequency, ω₀,

$$Δ β ( {ω}_{0} ) = {β}_{2} ( 2 {ω}_{0} ) - 2 {β}_{1} ( {ω}_{0} ) - \frac{2 π}{Λ} .$$

However, due to the dispersion of the waveguide, Δβ(ω) is generally non-zero at other frequencies ω=ω₀+Δω. This can be seen more clearly by expanding the phase mismatch in a Taylor series about the center pump frequency ω₀ as,

$$Δ β ( ω ) = {\sum }_{k = 0}^{∞} \frac{Δ {β}^{( k )} ( {ω}_{0} ) {( Δ ω )}^{k}}{k !} , {Δβ}^{( k )} ( {ω}_{0} ) = \frac{{\partial }^{k} Δ β ( ω )}{\partial {ω}^{k}} {\vert}_{ω = {ω}_{0}}$$

where Δω=ω−ω0. As discussed above, the zeroth order term,

$$Δ {β}^{( 0 )} = {β}_{2} ( 2 {ω}_{0} ) - 2 {β}_{1} ( {ω}_{0} ) - \frac{2 π}{Λ}$$

can be minimized to zero by appropriate choice of A, which is the essential function of periodic poling. As a result, the phase-matching bandwidth is dominantly determined by the first-order term Δβ⁽¹⁾ which is proportional to the group velocity mismatch between the pump and second-harmonic modes. A small value or even zero of Δβ⁽¹⁾ would result in a broad phase matching bandwidth.

For a waveguide, Δβ^{(k)} (k=1, 2, . . . ) generally contributes from two parts, the material dispersion that results from the dispersion of waveguide material, and the waveguide dispersion that results from the wave guidance of the waveguide. The latter is related to the waveguide geometry (defined by parameters W, H, h, and θ as shown in FIG. 2 and FIG. 3. The overall value of Δβ^{(k)} (k=1, 2, . . . ) can be changed by changing to the waveguide geometry. Therefore, appropriate design of the waveguide geometry could produce a waveguide dispersion to compensate the material one, leading to a small or even zero overall Δβ⁽¹⁾ that in turn results in a broad phase matching bandwidth. Unfortunately, for a short-wavelength spectral region such as the visible region, this is very challenging to do for conventional phase matching techniques such as type-0 QPM, since the material dispersion is so significant that it cannot be compensated by the waveguide dispersion with any waveguide dimensions.

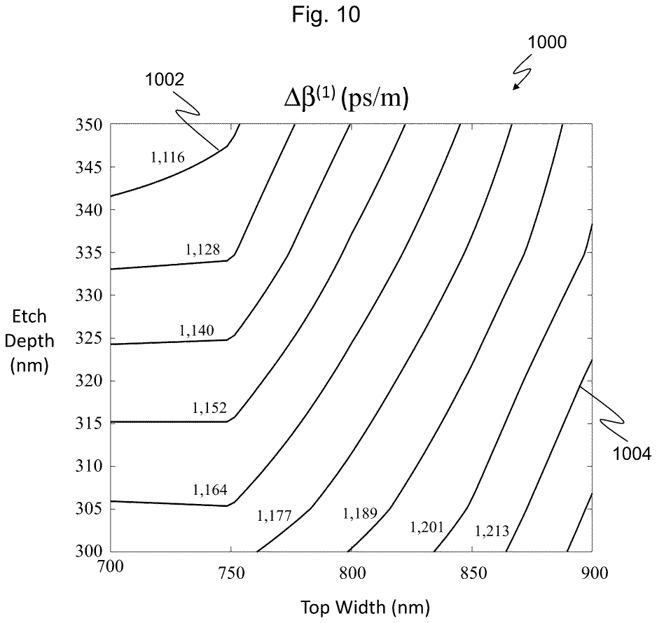

FIG. 10 shows an example of SHG from 1064 nm to 532 nm using the TE₀₀ mode for type-0 QPM in a partially etched 400 nm-thick X-Cut LNOI nanophotonic waveguide displaying the first order dispersion (Δβ⁽¹⁾ picoseconds per meter or ps/m) of the phase mismatch for the SHG process in the case of Type-0 phase matching. Shown are contours of constant Δβ⁽¹⁾ as functions of top width, W, and etch depth, h. Contour values ranging from 1,116 ps/m 1002 to 1,213 ps/m 1004 are displayed.

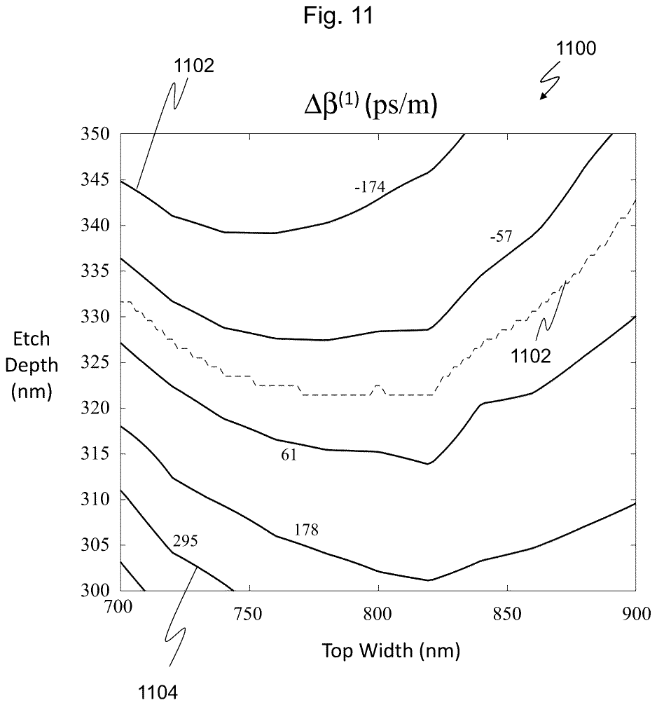

In contrast, FIG. 11 shows the first order dispersion (Δβ⁽¹⁾ ps/m) of the phase mismatch for the SHG process in the case of a TE₁₀ mode for the fundamental frequency. Shown are contours of constant Δβ⁽¹⁾ as functions of top width, W, and etch depth, h, for values ranging from −174 ps/m 1102 to 295 ps/m 1104 are displayed. The dashed line indicates the top width and etch depth combinations which give Δβ⁽¹⁾=0. It is noteworthy that for smaller top widths, the first order dispersion of the Type-0 interaction can approach 700 ps/m, but the waveguide becomes infeasibly small. The extent of possible top widths and etch depths shown is contracted for ease of illustration.

It is evident that Δβ⁽¹⁾ remains at a large magnitude regardless of the waveguide dimension. In contrast, as shown in FIG. 11, the inverse-intermodal QPM approach achieves Δβ⁽¹⁾=0 for a large range of waveguide dimensions, by using TE₁₀ for the 1064 nm mode and TE₀₀ for the 532 nm mode.

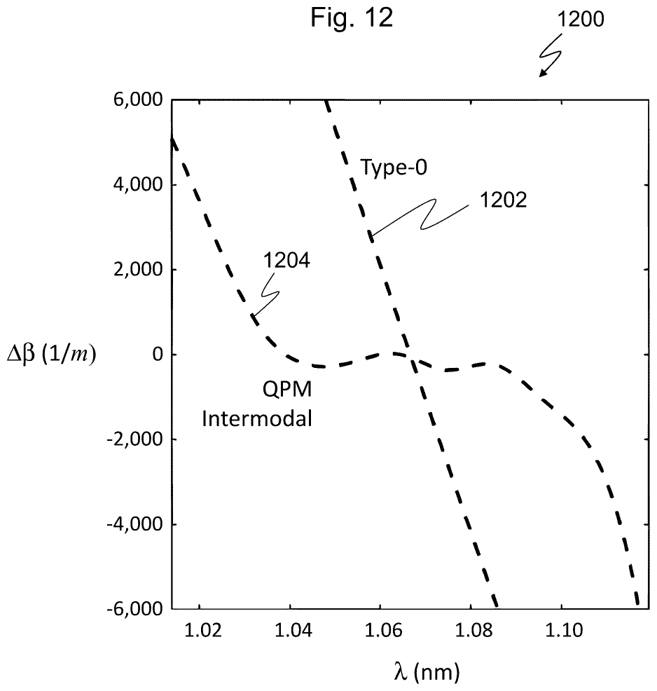

FIG. 12 shows the resulting overall phase mismatch (AB) 1200 for the Type-0 QPM 1202 and inverse-intermodal QPM 1204 as a function of bandwidth, λ (nm). The simulation results demonstrate that the inverse-intermodal QPM illustrated by the embodiment is able to achieve phase matching (Δβ≈0) over a broad bandwidth of 50 nm from about 1.04 μm to about 1.09 μm, while conventional type-0 QPM can only achieve phase matching over a narrow bandwidth around the wavelength of about 1.07 μm. In this example, inverse-intermodal QPM method achieves both the linear (Δβ⁽¹⁾) and quadratic (Δβ⁽²⁾) terms of the phase mismatch to zero. As a result, the phase mismatch is dominated only by cubic dispersion. This is impossible for the type-0 QPM approach.

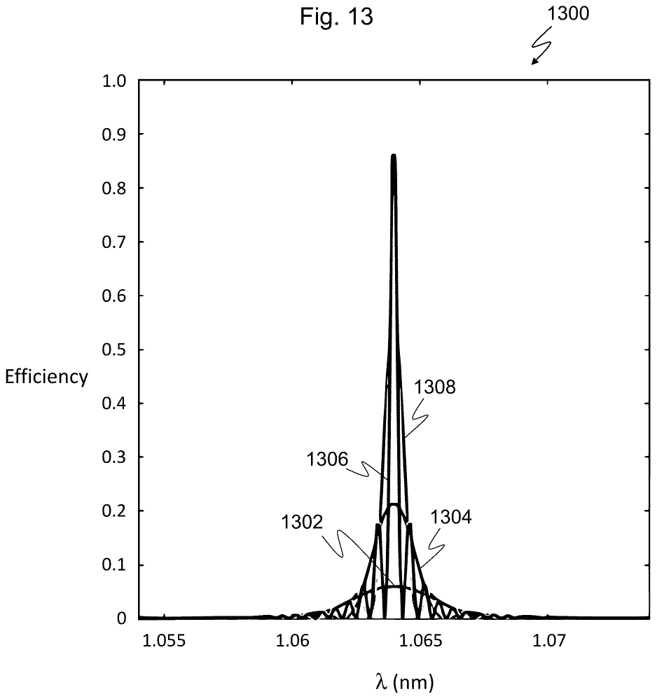

FIG. 13 shows the efficiency curve 1300 for the Type-0 process at various normalized propagation lengths, l, including l equal to 0.25 in value 1302, l equal to 0.5 in value 1304, l equal to 1.0 in value 1306, and l equal to 2.0 in value 1308.

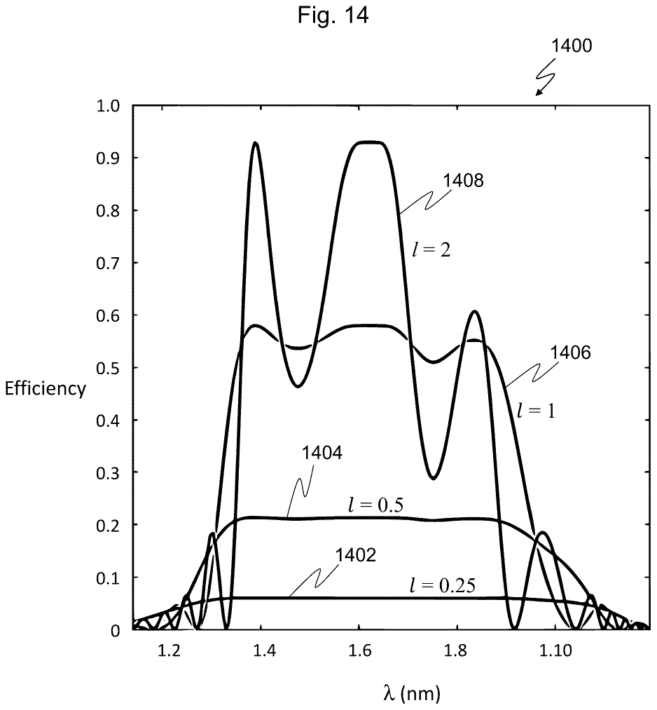

FIG. 14 shows the efficiency curve 1400 for the inverse-intermodal QPM process at various normalized propagation lengths including l equal to 0.25 in value 1402, l equal to 0.5 in value 1404, l equal to 1.0 in value 1406, and l equal to 2.0 in value 1408.

Comparing the exemplary results shown in FIG. 13 and FIG. 14, SHG exhibits a very narrow bandwidth of about 1 nm for type-0 QPM as shown in FIG. 13, while it remains at high efficiency over an unprecedentedly broad bandwidth with a full width at half maximum of 70 nm from 1.03 μm to 1.10 μm. This example illustrates the superiority of inverse-intermodal QPM for broadband frequency conversion, compared with existing methods.

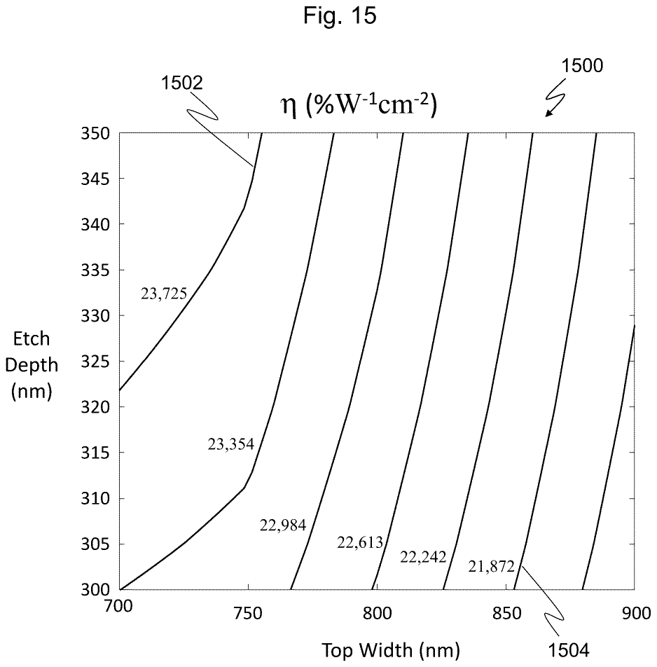

FIG. 15 shows simulation results for the normalized conversion efficiency of the SHG process in the case of Type-0 phase matching. Displayed are simulation results showing contours of constant normalized conversion efficiency 1500, η (% W⁻¹ cm⁻²) as a function of top width, W, and etched depth, h. Shown are contours of constant normalized conversion efficiency ranging from 23,725 in value 1502 to 21,872 in value 1504.

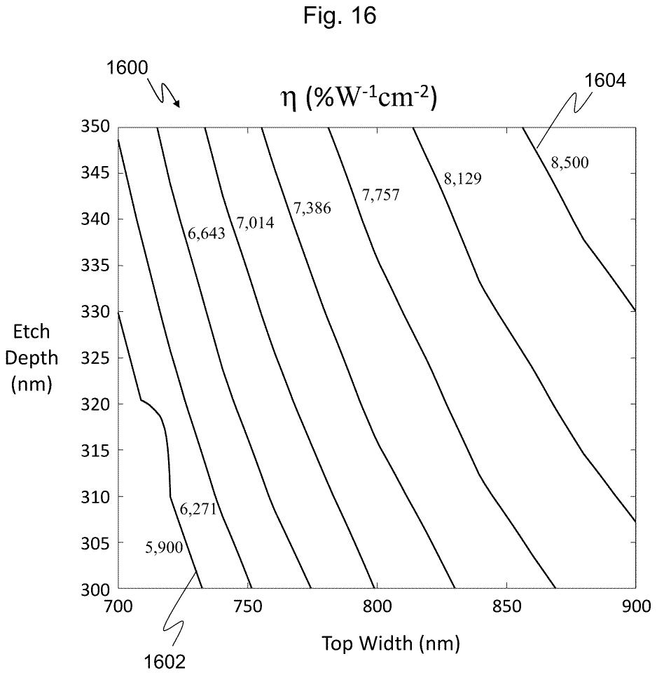

FIG. 16 shows simulation results for the normalized conversion efficiency of the SHG process in the case of an inverse-intermodal QMP process. Displayed are simulation results showing contours of constant normalized conversion efficiency 1600, n (% W⁻¹ cm⁻²) as a function of top width, W, and etched depth, h. Shown are contours of constant normalized conversion efficiency ranging from 5,900 in value 1602 to 8,500 in value 1604.

As shown, the inverse-intermodal QPM approach does come with a small expense that it exhibits a smaller slope conversion efficiency (conversion efficiency per unit length per unit pump power) compared with Type-0 QPM. FIG. 15 and FIG. 16 illustrates the effect, where the proposed approach exhibits a slope efficiency roughly half of that for Type-0 QPM. The underlying reason is that the slope efficiency depends on the spatial overlap between the pump and converted modes, with a value given by the following equation,

$$η = \frac{{ω}^{2}}{2 {ϵ}_{0} {c}^{3} {n}_{1}^{2} {n}_{2}} \frac{{( {χ}_{ijk}^{( 2 )} {ζ}_{ijk} )}^{2}}{{A}_{eff}}$$

where ζⱼⱼₖ is the nonlinear mode overlap and A_{eff} is the nonlinear effective mode area. The proposed approach utilizes different orders of guided modes which have a mode overlap factor smaller than the Type-0 QPM that utilizes only one fundamental guided mode.

However, the overall efficiency of frequency conversion of the nonlinear waveguide can be compensated by using a longer waveguide length, since the efficiency depends quadratically on the waveguide length as shown in the following equation:

$$\begin{matrix}Γ = {v}_{b}^{2} {sn}^{2} ( \frac{L / ℓ}{{v}_{b}} \vert {υ}_{b}^{4} ) \\ {v}_{b}^{- 1} = \frac{Δβ}{4} ℓ \pm \sqrt{1 + {( \frac{Δβ}{4} ℓ )}^{2}} \\ where , \\ ℓ = \frac{1}{\sqrt{η {P}_{o}}}\end{matrix}$$

is the nonlinear characteristic length with the normalized slope efficiency n and the input power P₀. As shown in FIG. 13 and FIG. 14 for an exemplary embodiment, the same conversion efficiency can be obtained with a same normalized length l=L/l. Of particular importance is that, in the proposed approach, the bandwidth of frequency conversion is nearly retained for different lengths, as benefited from the near-zero Δβ over a broad bandwidth. While in the Type-0 QPM, the bandwidth degrades quickly with propagation length, due to the strong frequency dependence of phase mismatch as in FIG. 12. The simulation results for the exemplary embodiments demonstrate that the inverse-intermodal QPM methods can achieve a substantially larger bandwidth than a Type-0 process of the same efficiency.

In the exemplary embodiments described herein, the use of a relatively spatially higher order laser pump mode (for example, transverse electric mode 10 (TE₁₀)) may be converted to a relatively lower order spatial mode (e.g.: fundamental transverse electric mode 00 (TE₀₀)) for the second harmonic. Other alternative embodiments may include using two TE₁₀ modes and combining the two using SFG to visible light. In some cases, the systems herein may control the TE₁₀ mode to operate close to the geometric waveguide cut-off wavelength. This may result in high geometric dispersion to match the strong material dispersion of the TE₀₀ mode of the converted visible light signal, resulting in a low GVM over a relatively broad bandwidth.

In some cases, the systems herein may include a non-linear color conversion component. This nonlinear color conversion component may include a waveguide with optical properties that are designed to reduce the group velocity mismatch for a higher order spatial mode of the input signal with the converted signal compared to a device designed for use with a fundamental spatial mode for the input signal. The waveguide may be periodically poled to provide quasi-phase matching at the center wavelength between the input and doubled frequency components via a χ⁽²⁾ effect. In some examples, the embodiments herein may include a device that uses an optical nonlinearity to convert from one wavelength to another. The optical nonlinearity may be designed to operate over a broad range of wavelengths and, as such, may minimize the group velocity mismatch between the input and the converted signals for efficient phase matching. The GVM minimization may be achieved by use of a higher order spatial mode for the input wavelength compared with the converted output wavelength.

In some embodiments, a system may be provided that includes a tunable laser source, and a nonlinear waveguide that has an optical nonlinearity. The nonlinear waveguide may be configured to convert an input beam provided by the tunable laser source from a current input wavelength to a specified output wavelength. In some cases, the input beam may include a spatial mode that is different in order than a fundamental spatial mode. Moreover, the converted output wavelength may include a spatial mode that is different in order than the spatial mode of the input beam. This wavelength conversion may reduce a first order dispersion of phase mismatch between the input wavelength and the output wavelength.

In other embodiments, the input beam may include a spatial mode that is higher in order than the fundamental spatial mode. In such cases, the converted output wavelength may include a lower order spatial mode visible output that is lower in order than the higher order spatial mode input beam. In some examples, the higher order spatial mode input beam may be phase-matched to the lower order spatial mode visible output. In some embodiments, the lower order spatial mode visible output may be wavelength tunable by tuning the higher order spatial mode input beam's wavelength. The system may be configured to maintain a first order dispersion phase mismatch between the higher order spatial mode input beam and the lower order spatial mode visible output below a specified maximum value over a specified wavelength bandwidth for the visible output.

Alternatively, in some embodiments, the input beam may include a spatial mode that has an order equivalent to that of the fundamental spatial mode, and the converted output wavelength may include a higher order spatial mode visible output that is higher in order than the fundamental spatial mode input beam. In such cases, the fundamental order spatial mode input beam may be phase-matched to the higher order spatial mode visible laser output. Moreover, in such cases, the higher order spatial mode visible output may be wavelength tunable by tuning the input beam's wavelength. In some cases, a first order dispersion phase mismatch between the fundamental order spatial mode input beam and the higher order spatial mode visible output may be maintained below a specified maximum value over a specified wavelength bandwidth for the visible output.

In some embodiments, the system may further include a converter positioned between the laser source and the nonlinear waveguide. In such cases, the converter may be configured to convert a laser output having a fundamental order spatial mode to the higher order spatial mode laser output. In other words, whichever spatial mode order the laser output is in, a converter may be provided to couple the laser output to the desired spatial mode order. Still further, in some embodiments, the nonlinear waveguide may be a nanophotonic waveguide. In some cases, the infrared laser source and the nonlinear waveguide that has the optical nonlinearity may be disposed on a photonic integrated circuit (PIC). In embodiments where a converter component is used, the converter component may also be disposed on the PIC.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specifications and/or claims, are to be construed as permitting both direct and indirect (i.e. via other elements or components) connection. In addition, the terms “a” or “an”, as used in the specifications and/or claims, are to be construed as meaning “at least one of.” Finally, for ease of use, the terms “including” and “having” (and their derivatives), as used in the specification and/or claims, are interchangeable with and have the same meaning as the word “comprising.”

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical, and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. A system comprising:
one or more light sources; and
a nonlinear waveguide comprising an optical nonlinearity configured to convert an input beam provided by the one or more light sources from a current input wavelength to a specified output wavelength,
wherein the input beam comprises a spatial mode that is different in order than a fundamental spatial mode,
wherein the converted output wavelength comprises a spatial mode that is different in order than the spatial mode of the input beam, and
wherein the wavelength conversion reduces a first order dispersion of phase mismatch between the input wavelength and the output wavelength.

2. The system of claim 1, wherein the input beam comprises a spatial mode that is higher in order than the fundamental spatial mode, and wherein the converted output wavelength comprises a lower order spatial mode visible output that is lower in order than the higher order spatial mode input beam.

3. The system of claim 2, wherein the higher order spatial mode input beam is phase-matched to the lower order spatial mode visible output.

4. The system of claim 2, wherein the lower order spatial mode visible output is wavelength tunable by tuning the higher order spatial mode input beam's wavelength.

5. The system of claim 4, where in a first order dispersion phase mismatch between the higher order spatial mode input beam and the lower order spatial mode visible output is maintained below a specified maximum value over a specified wavelength bandwidth for the visible output.

6. The system of claim 1, wherein the input beam comprises a spatial mode that is equivalent in order to the fundamental spatial mode, and wherein the converted output wavelength comprises a higher order spatial mode visible output that is higher in order than the fundamental spatial mode of the input beam.

7. The system of claim 6, wherein the fundamental order spatial mode input beam is phase-matched to the higher order spatial mode visible output.

8. The system of claim 6, wherein the higher order spatial mode visible output is wavelength tunable by tuning the input beam's wavelength.

9. The system of claim 8, wherein a first order dispersion phase mismatch between the fundamental spatial mode input beam and the higher order spatial mode visible output is maintained below a specified maximum value over a specified wavelength bandwidth for the visible output.

10. The system of claim 1, wherein the one or more light sources are configured to produce an output having a fundamental spatial mode, and further comprising a spatial mode converter positioned between the one or more light sources and the nonlinear waveguide, wherein the converter is configured to convert the output of the one or more light sources from the fundamental spatial mode to the higher order spatial mode output.

11. The system of claim 1, wherein the one or more light sources and the nonlinear waveguide including the optical nonlinearity are disposed on a photonic integrated circuit (PIC).

12. The system of claim 1, wherein the nonlinear waveguide comprises a nonphotonic waveguide.

13. The system of claim 1, wherein the wavelength conversion further reduces a second order dispersion of phase mismatch between the input wavelength and the output wavelength.

14. The system of claim 1, wherein the one or more light sources comprise at least one fixed wavelength light source and at least one tunable laser source.

15. The system of claim 1, wherein the one or more light sources comprise at least one fixed narrowband source and at least one broadband source.

16. The system of claim 15, wherein the fixed narrowband source or the broadband source or both provide a spatial mode output that is higher than a fundamental spatial mode.

17. A method for converting one optical wavelength to another wherein:
a light beam from one or more light sources is disposed on,
a nonlinear waveguide comprising an optical nonlinearity configured to convert said input beam provided by the one or more light sources from a current input wavelength to a specified output wavelength,
wherein the input beam comprises a spatial mode that is different in order than a fundamental spatial mode,
wherein the converted output wavelength comprises a spatial mode that is different in order than the spatial mode of the input beam, and
wherein the wavelength conversion reduces a first order dispersion of phase mismatch between the input wavelength and the output wavelength.
